(19) United States
(12) Patent Application Publication
(10) Pub. No.: US 2014/0364979 A1
(43) Pub. Date: Dec. 11, 2014

(54) INFORMATION PROCESSING APPARATUS, LOCATION DETERMINING METHOD, AND RECORDING MEDIUM CONTAINING LOCATION DETERMINING PROGRAM

(71) Applicants: Fumio YOSHIZAWA, Kanagawa (JP); Takeo TSUKAMOTO, Kanagawa (JP); Keisuke KONISHI, Kanagawa (JP)

(72) Inventors: Fumio YOSHIZAWA, Kanagawa (JP); Takeo TSUKAMOTO, Kanagawa (JP); Keisuke KONISHI, Kanagawa (JP)

(21) Appl. No.: 14/295,467

(22) Filed: Jun. 4, 2014

(30) Foreign Application Priority Data
Jun. 6, 2013 (JP) 2013-120069
Jan. 27, 2014 (JP) 2014-012571

(51) Int. Cl. G06K 9/00

(52) U.S. Cl. CPC G06K 9/00342
USPC 700/91

(57) ABSTRACT

An information processing apparatus includes a storage unit, an estimating unit, a judging unit, and a determining unit. The storage unit stores therein information of a walking state and a first location representing a location where the walking state occurs in an associated manner. The estimating unit estimates the walking state on the basis of measurement information measured in response to person's walking. When the walking state has been estimated, the judging unit judges whether or not the first location associated with the estimated walking state exists near a second location representing a location calculated by autonomous navigation based on the measurement information. When it has been judged that the first location exists near the second location, the determining unit determines the first location to be person's current location.

### CROSS-REFERENCE TO RELATED APPLICATIONS

The present application claims priority to and incorporates by reference the entire contents of Japanese Patent Application No. 2013-120069 filed in Japan on Jun. 6, 2013 and Japanese Patent Application No. 2014-012571 filed in Japan on Jan. 27, 2014.

### BACKGROUND OF THE INVENTION

1. Field of the Invention

The present invention relates to an information processing apparatus, a location determining method, and computer-readable recording medium that contains a location determining program.

2. Description of the Related Art

Conventionally, there are pedestrian positioning technologies using an autonomous navigation function built into a mobile terminal owned by a pedestrian. The autonomous navigation includes, as one aspect, measuring pedestrian's location by reflecting the direction and distance of pedestrian movement based on a starting point of the movement. Therefore, the autonomous navigation may cause accumulation of errors with the repetition of location measurements.

Accordingly, nowadays, map matching for correcting a location measurement error may be performed. The map matching includes, as one aspect, estimating pedestrian's location on the basis of various sensor values used in a measurement of the pedestrian's location and map information around the pedestrian, etc. As an example of the map matching, a traveling direction of a pedestrian is calculated from a value output from a geomagnetic field sensor, and, if there is a sudden change in the traveling direction, the location of an intersection or corner near the present place is determined to be pedestrian's current location by using map information. Furthermore, as another example of the map matching, altitude of a pedestrian is calculated from a value output from an atmospheric pressure sensor, and, if there is a sudden change in the altitude, the location of a stairs or elevator near the present place is determined to be pedestrian's current location by using map information.

However, the above-described conventional technology has a problem that the correction of a location measurement error due to the autonomous navigation cannot be performed with high quality. In the conventional technology, within an area of location measurement by the autonomous navigation, a place in which a change has occurred with a change in the direction of pedestrian movement, such as turning to the right, turning to the left, moving up, or moving down, is determined to be pedestrian's current location. Accordingly, unless the direction of pedestrian movement is changed, the conventional technology does not correct a location measurement error due to the autonomous navigation; therefore, it is not possible to perform the correction of a location measurement error due to the autonomous navigation with high quality.

In view of the above, there is a need to provide an information processing apparatus, a location determining method, and a computer-readable recording medium that contains a location determining program, that are capable of performing the correction of a location measurement error due to autonomous navigation with high quality.

### SUMMARY OF THE INVENTION

It is an object of the present invention to at least partially solve the problems in the conventional technology.

According to the present invention, there is provided an information processing apparatus comprising: a storage unit that stores therein information of a walking state and a first location representing a location where the walking state occurs in an associated manner; an estimating unit that estimates the walking state on the basis of measurement information measured in response to person's walking; a judging unit that judges, when the walking state has been estimated, whether or not the first location associated with the estimated walking state exists near a second location representing a location calculated by autonomous navigation based on the measurement information; and a determining unit that determines, when it has been judged that the first location exists near the second location, the first location to be person's current location.

The present invention also provides a location determining method comprising: estimating person's walking state on the basis of measurement information measured in response to person's walking; judging, when the walking state has been estimated, whether or not a first location corresponding to the estimated walking state exists near a second location representing a location calculated by autonomous navigation based on the measurement information on the basis of correspondence information that associates information of the walking state with the first location representing a location where the walking state occurs; and determining, when it has been judged that the first location exists near the second location, the first location to be person's current location.

The present invention also provides a non-transitory computer-readable recording medium that contains a location determining program causing a computer to execute: estimating person's walking state on the basis of measurement information measured in response to person's walking; judging, when the walking state has been estimated, whether or not a first location corresponding to the estimated walking state exists near a second location representing a location calculated by autonomous navigation based on the measurement information on the basis of correspondence information that associates information of the walking state with the first location representing a location where the walking state occurs; and determining, when it has been judged that the first location exists near the second location, the first location to be person's current location.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an application example of an information processing apparatus according to a first embodiment of the present invention;

FIG. 2 is a functional block diagram illustrating a configuration example of the information processing apparatus according to the first embodiment;

FIG. 3 is a diagram illustrating an example of directions of acceleration and angular velocity;

FIG. 4 is a diagram illustrating an example of an angle output from a geomagnetic field sensor;

FIG. 5 is a diagram illustrating an example of a route for explaining waveforms of measurement information;

FIG. 6 is a diagram illustrating an example of the waveforms of the measurement information;

FIG. 7 is a diagram illustrating an example of a waveform model that occurs by person's walking motion;

FIG. 8 is a diagram illustrating a relation between acceleration and step length;

FIG. 9 is a diagram illustrating an example of an image of calculation of a second location;

FIG. 10 is a diagram illustrating an example of correspondence information;

FIG. 11 is a diagram illustrating an example of a floor where a person makes a walking motion;

FIG. 12 is a diagram illustrating examples of waveform models that occur by predetermined walking states;

FIG. 13 is a flowchart illustrating an example of the flow of a location determining process according to the first embodiment;

FIG. 14 is a diagram illustrating an example of a result of location measurement according to the first embodiment;

FIG. 15 is a diagram illustrating an example of a result of location measurement according to the first embodiment; and

FIG. 16 is a diagram illustrating an example of a result of location measurement according to the first embodiment.

### DETAILED DESCRIPTION OF THE PREFERRED EMBODIMENTS

Exemplary embodiments of an information processing apparatus, a location determining method, and a computer-readable recording medium that contains a location determining program according to the present invention will be explained below with reference to accompanying drawings. Incidentally, the present invention is not limited to tyle embodiments described below.

### First Embodiment

### Application Example of Information Processing Apparatus

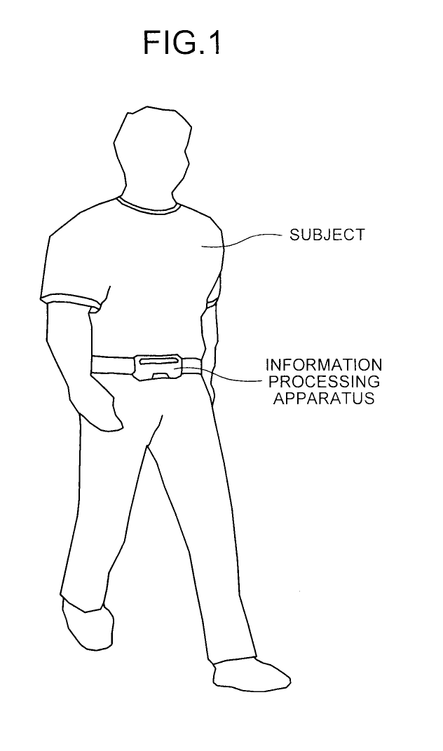

An application example of an information processing apparatus according to a first embodiment is explained with FIG. 1. FIG. 1 is a diagram illustrating the application example of the information processing apparatus according to the first embodiment.

As shown in FIG. 1, the information processing apparatus is information equipment fitted on a subject (a person) who is subject to location identification. The body part fitted with the information processing apparatus is, for example, the abdomen which is the center of gravity of the human body. Accordingly, the acceleration and angular velocity acting on the center of gravity of the human body can be measured with high accuracy. However, the fitting of the information processing apparatus on the abdomen is just an example, and the body part fitted with the information processing apparatus is not strictly specified and varies according to content of body information that one wants to measure.

Apparatus Configuration According to First Embodiment

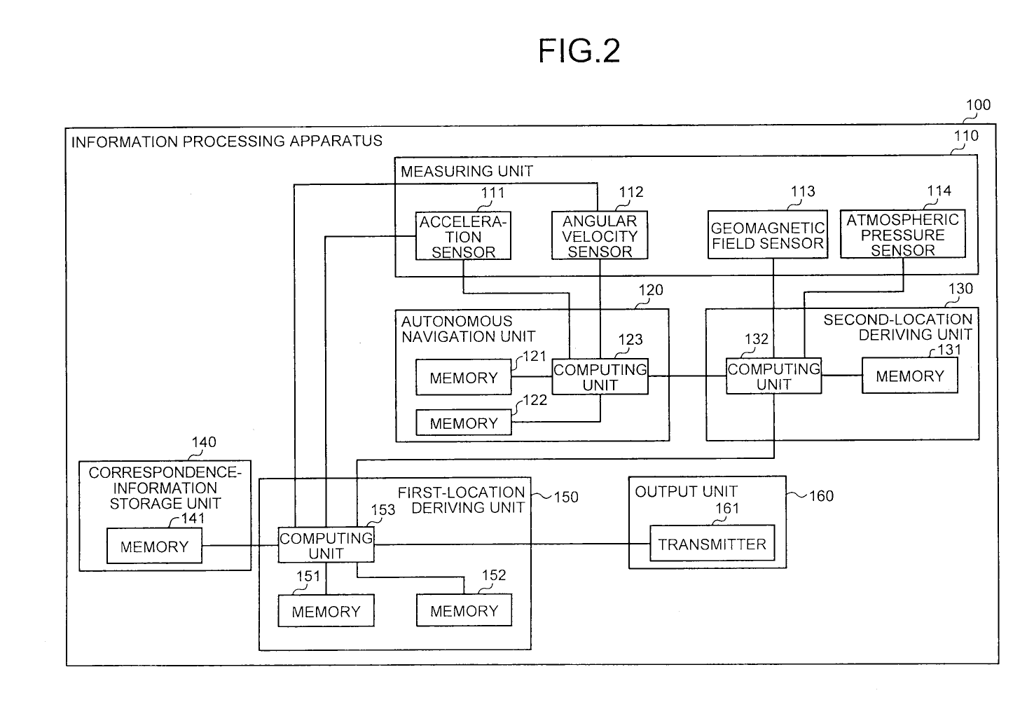

Subsequently, a configuration of the information processing apparatus according to the first embodiment is explained with FIG. 2. FIG. 2 is a functional block diagram showing a configuration example of the information processing apparatus according to the first embodiment.

As shown in FIG. 2, an information processing apparatus 100 includes a measuring unit 110, an autonomous navigation unit 120, a second-location deriving unit 130, a correspondence-information storage unit 140, a first-location deriving unit 150, and an output unit 160.

The measuring unit 110 measures measurement information. The measuring unit 110 includes an acceleration sensor 111, an angular velocity sensor 112, a geomagnetic field sensor 113, and an atmospheric pressure sensor 114. The acceleration sensor 111 measures the acceleration acting on the information processing apparatus 100 as a piece of measurement information. Specifically, the acceleration sensor 111 measures the acceleration acting on the information processing apparatus 100 at regular intervals, and outputs X, Y, and Z components of the measured acceleration as numerical values to the first-location deriving unit 150. The angular velocity sensor 112 measures the angular velocity of the information processing apparatus 100 as a piece of measurement information. Specifically, the angular velocity sensor 112 measures the angular velocity of the information processing apparatus 100 at regular intervals, and outputs pitch, roll, and yaw components of the measured angular velocity as numerical values to the first-location deriving unit 150.

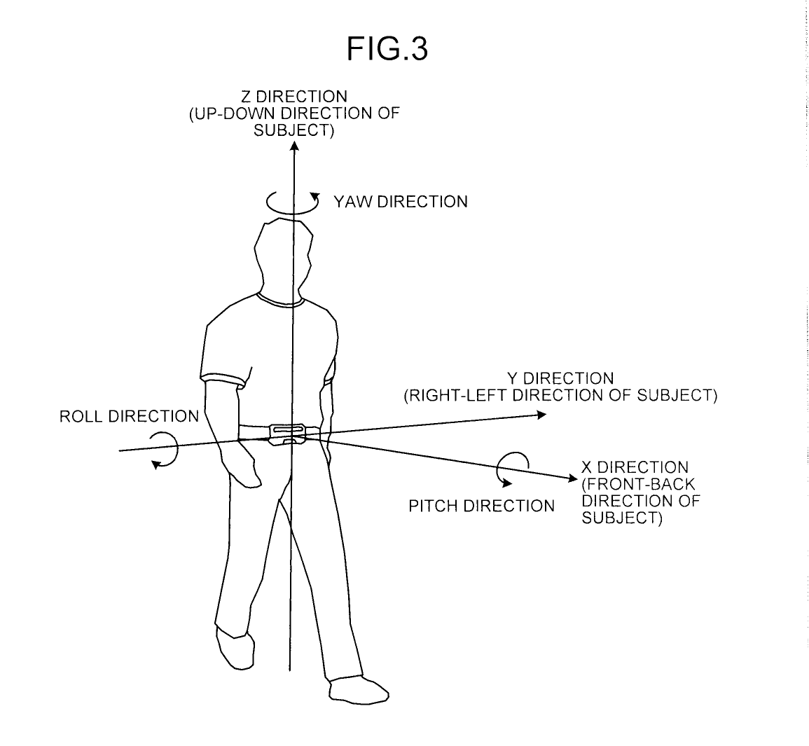

FIG. 3 is a diagram illustrating an example of directions of the acceleration and the angular velocity. As shown in FIG. 3, the X component of the acceleration corresponds to an X direction which is a front-back direction of the subject; the Y component corresponds to a Y direction which is a right-left direction of the subject; and the Z component corresponds to a Z direction which is an up-down direction of the subject. Furthermore, the pitch direction of the angular velocity corresponds to a direction of rotating about an X-direction axis; the roll direction corresponds to a direction of rotating about a Y-direction axis; and the yaw direction corresponds to a direction of rotating about a Z-direction axis.

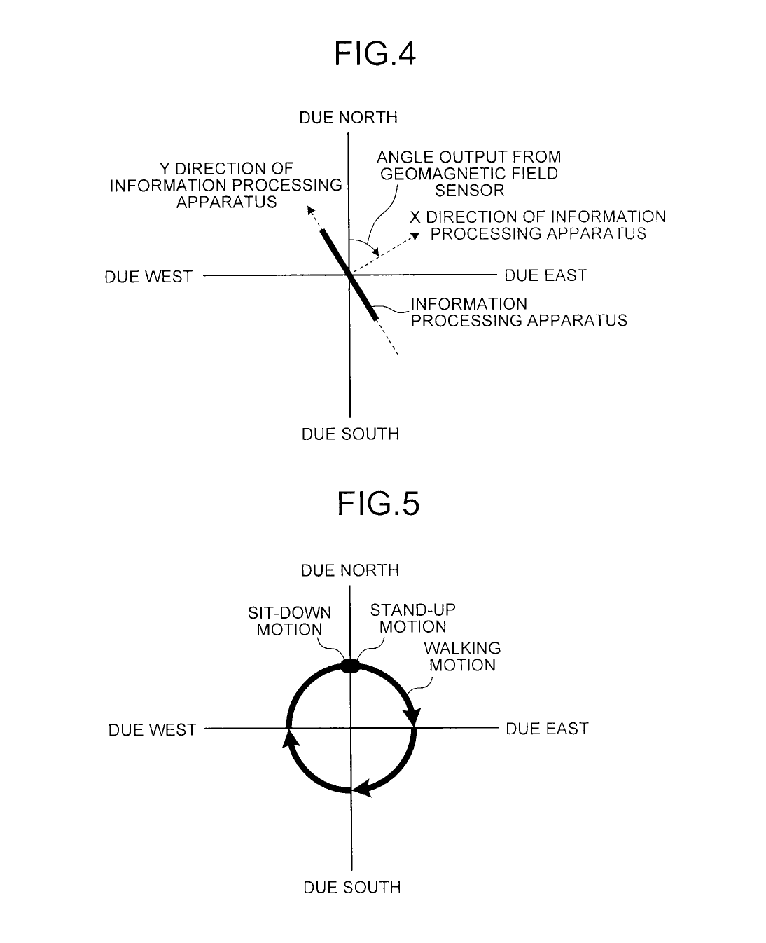

The geomagnetic field sensor 113 measures the geomagnetic field near the information processing apparatus 100 as a piece of measurement information. Specifically, the geomagnetic field sensor 113 measures the geomagnetic field near the information processing apparatus 100 at regular intervals, and outputs the direction of the information processing apparatus 100 expressed as an angle to due north (i.e., due north corresponds to 0 degrees) to the second-location deriving unit 130. FIG. 4 is a diagram illustrating an example of the angle output from the geomagnetic field sensor 113. As shown in FIG. 4, the angle (the direction of the information processing apparatus 100) output from the geomagnetic field sensor 113 is an angle between the due north and the X direction of the information processing apparatus 100. In the present embodiment, the information processing apparatus 100 is fastened to the person's abdomen; therefore, the direction of the person can be calculated from the angle between the due north and the X direction of the information processing apparatus 100.

The atmospheric pressure sensor 114 measures the atmospheric pressure near the information processing apparatus 100 as a piece of measurement information. Specifically, the atmospheric pressure sensor 114 measures the atmospheric pressure near the information processing apparatus 100 at regular intervals, and outputs a numerical value representing an altitude corresponding to the measured atmospheric pressure to the second-location deriving unit 130.

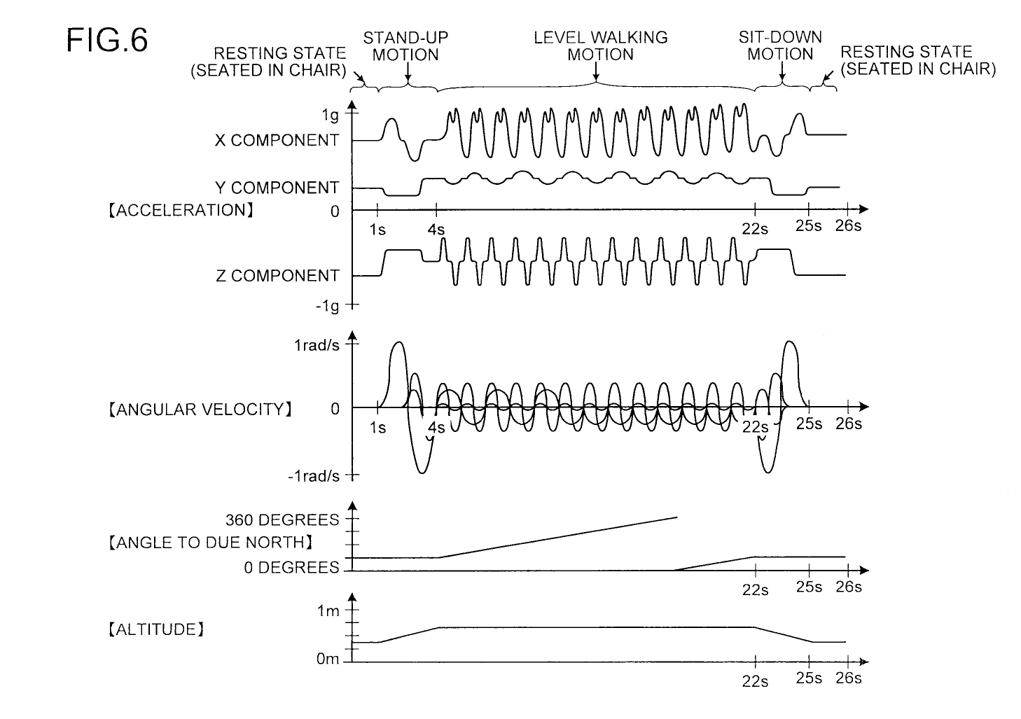

Here, waveforms of measurement information measured by the measuring unit 110 are explained. FIG. 5 is a diagram illustrating an example of a route for explaining the waveforms of the measurement information. FIG. 6 is a diagram illustrating an example of the waveforms of the measurement information. For example, as shown in FIG. 5, the person fitted with the information processing apparatus 100 makes motions of “rising from a chair (a stand-up motion), and walking in a due east direction, a due south direction, a due west direction, and a due north direction sequentially (a walking motion), and then sitting in the chair (a sit-down motion)”. Output waveforms of respective pieces of measurement information measured by the acceleration sensor 111, the angular velocity sensor 112, the geomagnetic field sensor 113, and the atmospheric pressure sensor 114 when these motions have been made are as shown in FIG. 6.

As shown in FIG. 6, while the person is seated in the chair (from 0 s to 1 s, from 25 s to 26 s), the acceleration sensor 111 outputs a fixed value, and the angular velocity sensor 112 outputs 0. That is, while the person is seated in the chair, the center of gravity of the person does not move; therefore, the acceleration sensor 111 outputs a fixed value, and the angular velocity sensor 112 outputs 0. Only X, Y, and Z components of gravitational acceleration are output from the acceleration sensor 111. Furthermore, while the person is walking (from 4 s to 22 s), periodicity is seen in the output waveforms from the acceleration sensor 111 and the angular velocity sensor 112. This indicates that while the person is walking, the center of gravity of the person moves regularly. Incidentally, in FIG. 6, the walking motion is a “level walking motion” which means walking around a level place. Furthermore, as the due north is set as 0 degrees, the output waveform from the geomagnetic field sensor 113 shows a gradual increase; however, when the person returns to the location of the chair where the person was seated initially, it becomes the same value as an initial value. Moreover, the place where the person walks is level; therefore, while the person is walking, a value of the output waveform from the atmospheric pressure sensor 114 is increased by a difference in altitude between when the person is in a seated state and when the person is in a standing state.

To return to the explanation of FIG. 2, the autonomous navigation unit 120 estimates the person's step length from the output waveforms of the measurement information measured by the acceleration sensor 111 and the angular velocity sensor 112. The autonomous navigation unit 120 includes a memory 121, a memory 122, and a computing unit 123. The memory 121 temporarily stores therein measurement information (numerical values) of acceleration measured by the acceleration sensor 111 and measurement information (numerical values) of angular velocity measured by the angular velocity sensor 112. The storage of the measurement information in the memory 121 is performed by the computing unit 123. The memory 122 stores therein a model of a waveform (referred to as a “waveform model”) that occurs by person's walking motion.

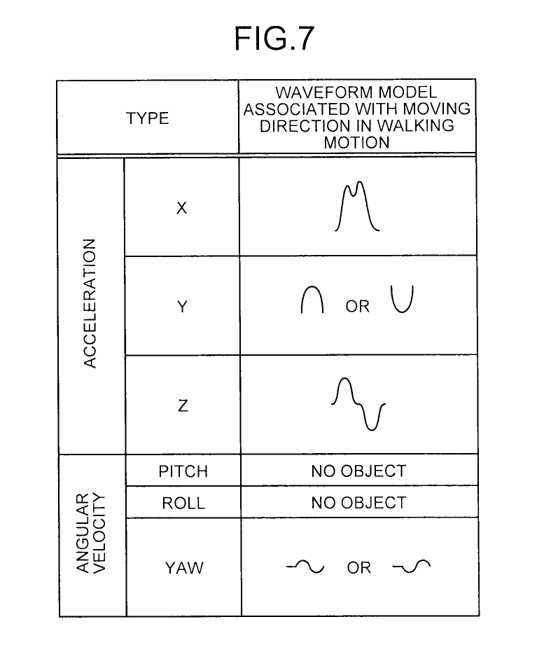

FIG. 7 is a diagram showing an example of the waveform model that occurs by person's walking motion. As shown in FIG. 7, the memory 122 stores therein a waveform model associated with a moving direction in walking motion estimated from measurement information of the acceleration (in the X, Y, and Z directions). In addition, the memory 122 stores therein a waveform model associated with a moving direction in walking motion estimated from measurement information of the angular velocity (in the pitch, roll, and yaw directions).

The computing unit 123 estimates the person's step length on the basis of measurement information. Specifically, the computing unit 123 receives numerical values of acceleration measured by the acceleration sensor 111 and numerical values of angular velocity measured by the angular velocity sensor 112. Then, the computing unit 123 temporarily stores the numerical values of acceleration and the numerical values of angular velocity in the memory 121, and reproduces respective output waveforms. Then, the computing unit 123 determines whether or not there are any waveforms similar to the reproduced output waveforms with reference to the waveform models stored in the memory 122. To take an example with FIGS. 6 and 7, the output waveforms in a period from 4 s to 22 s shown in FIG. 6 are similar to the waveform model shown in FIG. 7; therefore, the computing unit 123 deems that the person is making a walking motion, and calculates the person's step length in the walking motion. As one mode of the way of calculating the step length, a method of calculating the step length from a relation between acceleration and step length can be used as described below.

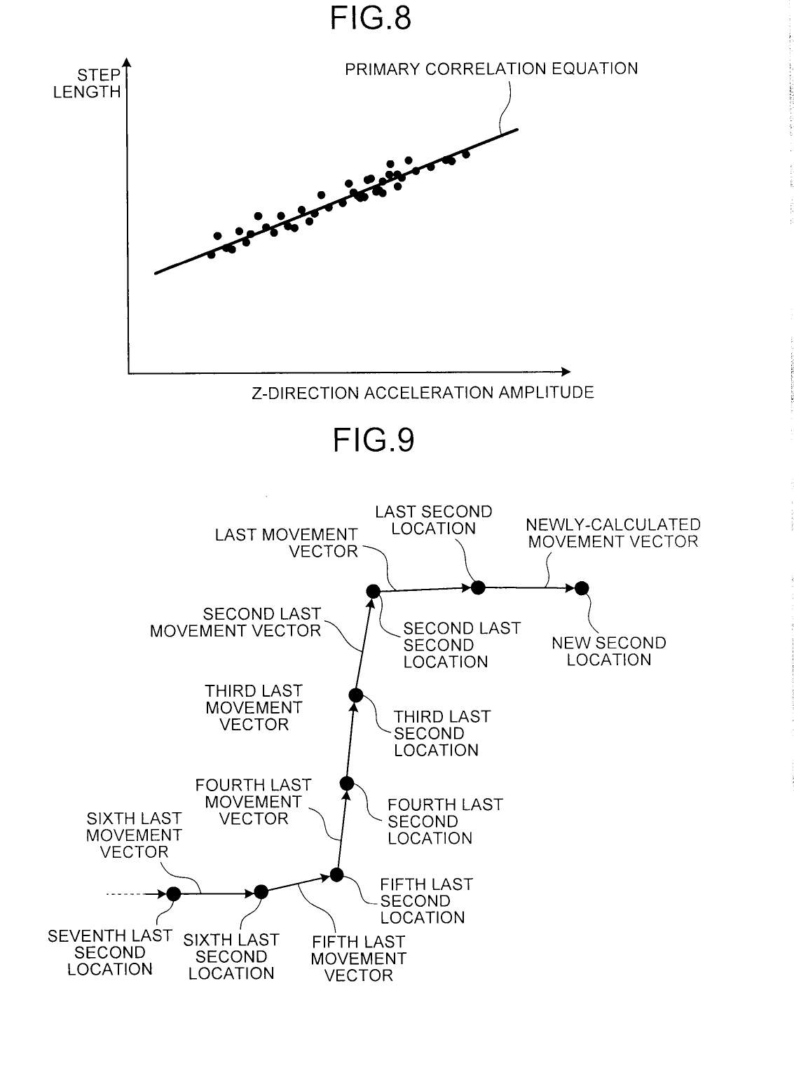

FIG. 8 is a diagram illustrating the relation between acceleration and step length. It is commonly known that there is a primary correlation between “Z-direction acceleration amplitude” and “step length” as shown in FIG. 8. Accordingly, the computing unit 123 calculates “step length” from “Z-direction acceleration amplitude” due to person's walking motion by using the primary correlation shown in FIG. 8. Then, the computing unit 123 outputs the calculated step length to the second-location deriving unit 130. Incidentally, the way of calculating the step length is not limited to the above-described method.

The second-location deriving unit 130 estimates person's current location. The second-location deriving unit 130 includes a memory 131 and a computing unit 132. The memory 131 stores therein map information. The computing unit 132 estimates person's current location from the person's step length output from the computing unit 123, the direction of the information processing apparatus 100 measured by the geomagnetic field sensor 113, and the altitude of the information processing apparatus 100 measured by the atmospheric pressure sensor 114.

Specifically, the computing unit 132 receives the person's step length output from the computing unit 123, the direction of the information processing apparatus 100 measured by the geomagnetic field sensor 113, and the altitude of the information processing apparatus 100 measured by the atmospheric pressure sensor 114. Then, the computing unit 132 calculates a travel distance of the person from the step length, and calculates a traveling direction of the person from respective change amounts of the direction and altitude of the information processing apparatus 100, thereby generating a movement vector. Then, the computing unit 132 adds the generated movement vector to the last estimated location, thereby estimating a new current location. After that, the computing unit 132 outputs the estimated current location to the first-location deriving unit 150. Incidentally, the current location estimated by the computing unit 132 is an example of a “second location”.

FIG. 9 is a diagram showing an example of an image of calculation of a second location. As shown in FIG. 9, the computing unit 132 adds a movement vector calculated from the step length, direction, and altitude to the last estimated location (the last second location), and calculates person's current location (a new second location). In the example in FIG. 9, an image of the last seven estimated locations (the last seven second locations) and estimation of person's latest current location (a new second location) is depicted.

Incidentally, in the estimation of a location by the computing unit 132, map matching can be adopted. Specifically, the computing unit 132 reads out map information around the estimated current location from the memory 131, and looks for a spot in which the direction or altitude of the person can change suddenly. A spot in which the direction or altitude of the person can change suddenly is, for example, a place where a crossroad, a corner, a stairs, a sloping road, or an elevator, etc. exists. Then, when a spot in which the direction or altitude of the person can change suddenly has been detected around the current location, the computing unit 132 determines the detected spot to be a new current location.

The correspondence-information storage unit 140 stores therein information of person's walking state and a first location in an associated manner. The correspondence-information storage unit 140 includes a memory 141. The memory 141 stores therein information of person's walking state and a first location representing a location where the walking state occurs in an associated manner. The person's walking state here means any of predetermined walking states, for example, “stride”, “stumble”, “sidle”, and “slouchy walk”. The “stride” is a walking state that occurs in a location where there is a threshold sill or a bump, etc. The “stumble” is a walking state that occurs in a location where there is a floor box, etc. The “sidle” is a walking state that occurs in an alleyway, etc. The “slouchy walk” is a walking state that occurs in a low-ceilinged passage, etc. Incidentally, the predetermined walking states are not limited to those described above as examples.

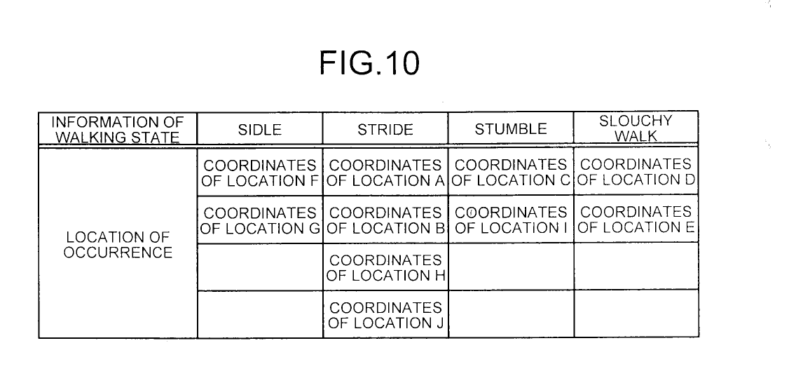

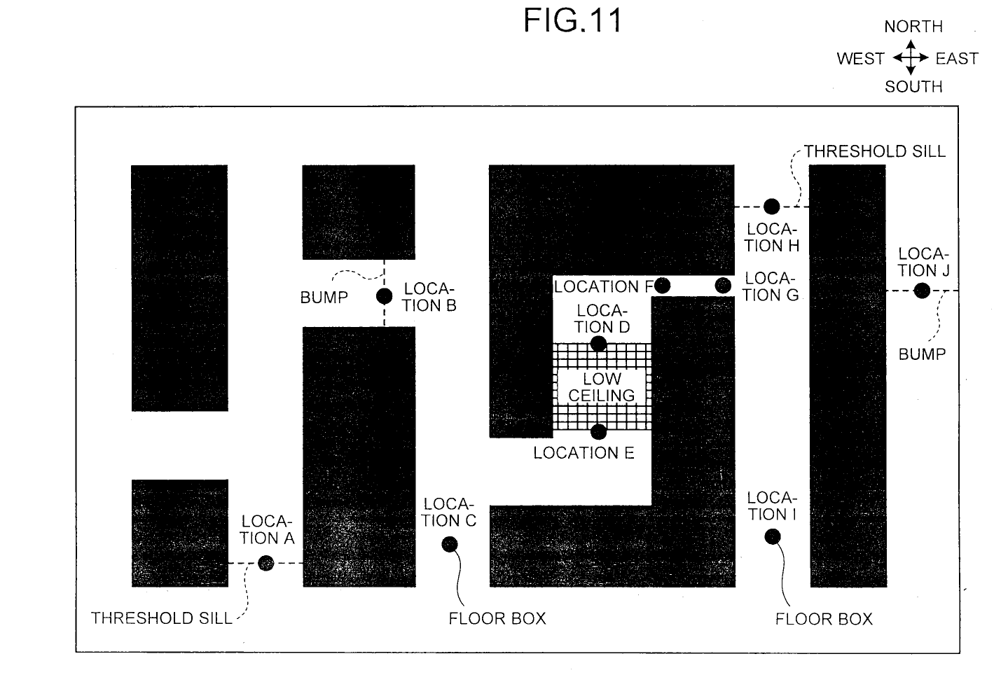

FIG. 10 is a diagram showing an example of correspondence information. FIG. 11 is a diagram showing an example of a floor where a person makes a walking motion. As shown in FIG. 10, the correspondence information is information that associates information of a walking state with a location where the walking state occurs. Such correspondence information is generated from a floor map as shown in FIG. 11. For example, as shown in FIG. 11, locations F and G are an alleyway. Accordingly, as shown in FIG. 10, the correspondence information includes information that associates “sidle”, a walking state (information of a walking state), with “coordinates of location F” and “coordinates of location G”, locations of occurrence. This means that a walking state is “sidle” around the “coordinates of location F” and the “coordinates of location G”. Incidentally, locations A to J are examples of a “first location”.

As described above, the predetermined walking states are not limited to the above-described examples. However, a result of demonstration of how a predetermined walking state is determined can be efficiently obtained by focusing on the following two points.

The first point is to focus on a thing that has been installed in a passage where the person walks and can be an obstacle to person's walking. However, a spot where a large obstacle has been placed thereby making it difficult for the person to walk is not suitable as a passage where the person walks, so we do not focus on such a spot. That is, we focus on only an obstacle that does not obstruct person's walking (through a spot). In a spot where such an obstacle exists, it is conceivable that the person goes into a walking state such as “stride” or “stumble” when the person passes through the obstacle.

The second point is to focus on a change in structure, such as the width and height of a passage where the person walks. In a spot where a change in structure is generated, a walking state may also be changed. For example, when the person enters a passage whose width is narrower than the person's shoulder width, it is conceivable that the person goes into a walking state such as “sidle”. Furthermore, for example, when the person enters a passage with a ceiling lower than the person's height, it is conceivable that the person goes into a walking state such as “slouchy walk”. By focusing on these two points, suitable correspondence information can be generated.

The first-location deriving unit 150 estimates a walking state, and determines person's current location on the basis of the estimated walking state. The first-location deriving unit 150 includes a memory 151, a memory 152, and a computing unit 153. The memory 151 temporarily stores therein measurement information (numerical values) of acceleration measured by the acceleration sensor 111 and measurement information (numerical values) of angular velocity measured by the angular velocity sensor 112. The storage of the measurement information in the memory 151 is performed by the computing unit 153. The memory 152 stores therein a waveform model that occurs by a predetermined walking state.

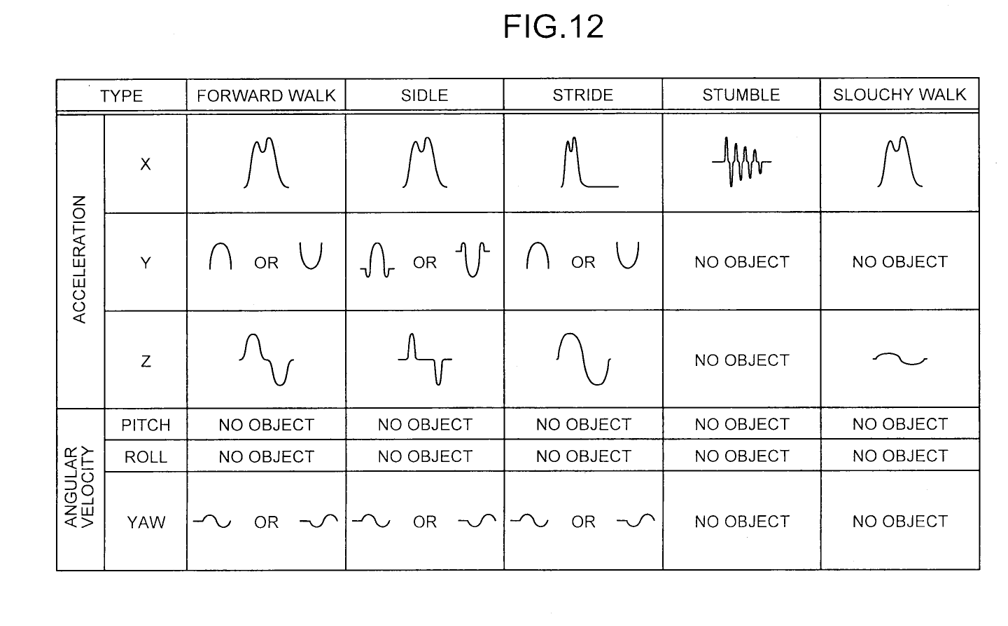

FIG. 12 is a diagram showing examples of waveform models that occur by the predetermined walking states. As shown in FIG. 12, the memory 152 stores therein respective waveform models associated with predetermined walking states in walking motion estimated from measurement information of the acceleration (in the X, Y, and Z directions). In addition, the memory 152 stores therein respective waveform models associated with predetermined walking states in walking motion estimated from measurement information of the angular velocity (in the pitch, roll, and yaw directions). That is, a waveform model associated with person's walking state, which is different from the waveform model associated with person's moving direction stored in the memory 122, is stored in the memory 152. Specifically, the waveform model stored in the memory 152 is a waveform model expressed in a more detailed shape than the waveform model stored in the memory 122. For example, the waveform model stored in the memory 152 is used in the estimation of person's predetermined walking state to be described later; therefore, the waveform model represents the shapes of amplitude, rates of rise and fall, overshoot, undershoot, and the presence or absence of ringing, etc.

The computing unit 153 estimates person's walking state, and, if a first location corresponding to the estimated walking state exists near a second location, determines the first location to be person's current location. The computing unit 153 is an example of an “estimating unit”, a “judging unit”, and a “determining unit”. Specifically, the computing unit 153 receives numerical values of acceleration measured by the acceleration sensor 111 and numerical values of angular velocity measured by the angular velocity sensor 112. Furthermore, the computing unit 153 receives person's current location (a second location) estimated by the computing unit 132. Then, the computing unit 153 temporarily stores the numerical values of acceleration and the numerical values of angular velocity in the memory 151, and reproduces respective output waveforms.

Then, the computing unit 153 determines whether or not there are any waveforms similar to the reproduced output waveforms with reference to the waveform models stored in the memory 152. When the computing unit 153 has determined that there is a waveform model similar to the reproduced output waveforms, the computing unit 153 presumes that the person is making a walking motion. Here, in addition to the presumption that the person is making a walking motion, the computing unit 153 can estimate a predetermined walking state. That is, the computing unit 123 has also detected that the person is walking; however, the computing unit 153 further estimates person's predetermined walking state in addition to estimating that the person is walking. Incidentally, when the computing unit 153 has determined that there is no waveform model similar to the reproduced output waveforms, the computing unit 153 outputs the person's current location (the second location) received from the computing unit 132 to the output unit 160. That is, when there are no output waveforms similar to any waveform models stored in the memory 152, a predetermined walking state is not estimated, and determination of the current location depending on a predetermined walking state to be described later is not performed because person's walking state is a normal walking state.

After that, the computing unit 153 acquires coordinates of a location (a first location) corresponding to the estimated walking state (information of a walking state) with reference to the correspondence information stored in the memory 141. Then, the computing unit 153 determines whether or not the coordinates of the location (the first location) corresponding to the estimated walking state exists near the person's current location (the second location) received from the computing unit 132. When the computing unit 153 has determined that the first location exists near the second location, the computing unit 153 determines the first location to be a new current location. That is, when a predetermined walking state in person's walking states has been detected, not person's current location calculated from the autonomous navigation but a current location according to is adopted. Then, the computing unit 153 outputs the determined person's current location (the first location) to the output unit 160.

Incidentally, when the computing unit 153 has determined that the first location does not exist near the second location, the computing unit 153 outputs the second location as person's current location to the output unit 160. A cause of the non-existence of the first location corresponding to the predetermined walking state near the second location despite even though the predetermined walking state has been estimated is because of the occurrence of an error in measurement information or because the person has made a motion corresponding to a predetermined walking state in a spot where the predetermined walking state could never occur. Therefore, in such a case, the second location is just determined to be person's current location.

The output unit 160 outputs a processing result of a process performed by the information processing apparatus 100. The output unit 160 includes a transmitter 161. The transmitter 161 transmits person's current location. Specifically, the transmitter 161 receives person's current location from the computing unit 153. Then, the transmitter 161 transmits the received person's current location to an external device by wireless communication, etc. As a wireless communication system, for example, Bluetooth™ or Wi-Fi™ (Wireless Fidelity), etc. is adopted. Incidentally, the person's current location transmitted from the transmitter 161 is either the first location or the second location.

Flow of Location Determining Process According to First Embodiment

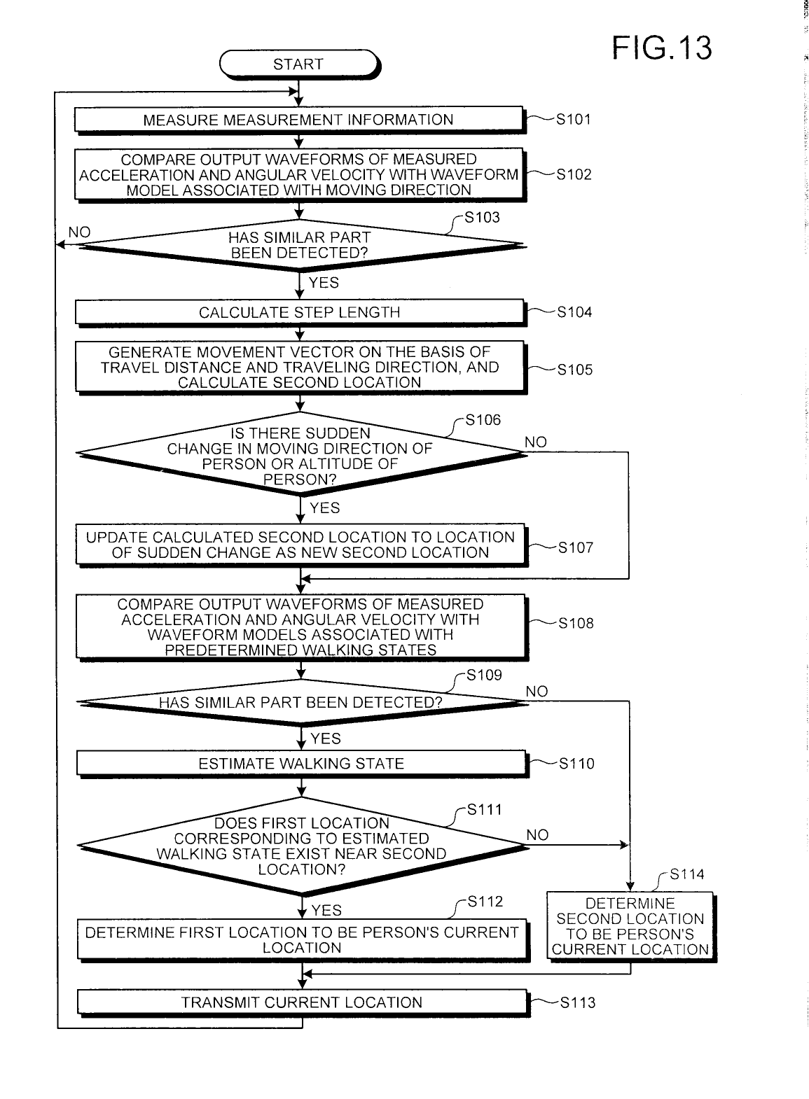

Subsequently, the flow of a location determining process according to the first embodiment is explained with FIG. 13. FIG. 13 is a flowchart showing an example of the flow of the location determining process according to the first embodiment.

As shown in FIG. 13, the acceleration sensor 111, the angular velocity sensor 112, the geomagnetic field sensor 113, and the atmospheric pressure sensor 114 measure measurement information of the acceleration, angular velocity, geomagnetic field, and atmospheric pressure of the information processing apparatus 100, respectively (Step S101). The computing unit 123 compares output waveforms of the measured acceleration and angular velocity with a waveform model associated with a moving direction in person's walking motion (Step S102). When the computing unit 123 has detected part of the output waveforms similar to the waveform model (YES at Step S103), the computing unit 123 calculates person's step length, for example, from a primary correlation between acceleration and step length (Step S104). On the other hand, when the computing unit 123 has not detected any part of the output waveforms similar to the waveform model (NO at Step S103), the process at Step S101 is performed again.

The computing unit 132 calculates a travel distance of the person from the step length calculated by the computing unit 123, and calculates a traveling direction of the person from respective change amounts of the direction and altitude of the information processing apparatus 100 measured by the geomagnetic field sensor 113 and the atmospheric pressure sensor 114. Then, the computing unit 132 generates a movement vector on the basis of the calculated travel distance and traveling direction, and adds the generated movement vector to the last estimated location, thereby calculating a new second location (Step S105). Furthermore, the computing unit 132 reads out map information around the calculated second location from the memory 131, and determines whether or not there is any spot in which the direction or altitude of the person can change suddenly (Step S106).

When the computing unit 132 has determined that there is a spot in which the direction or altitude of the person can change suddenly (YES at Step S106), the computing unit 132 updates the calculated second location to a location of the spot in which the direction or altitude of the person can change suddenly and sets the spot as a new second location (Step S107). On the other hand, when the computing unit 132 has determined that there is no spot in which the direction or altitude of the person can change suddenly (NO at Step S106), without any further update of the second location, a process at Step S108 is performed.

The computing unit 153 compares output waveforms of the measured acceleration and angular velocity with waveform models associated with predetermined walking states in person's walking motion (Step S108). When the computing unit 153 has detected part of the output waveforms similar to any of the waveform models (YES at Step S109), the computing unit 153 estimates person's predetermined walking state (Step S110). Then, the computing unit 153 determines whether or not a first location corresponding to the estimated walking state exists near the second location calculated by the computing unit 132 with reference to correspondence information (Step S111). When the computing unit 153 has determined that the first location exists near the second location (YES at Step S111), the computing unit 153 determines the first location to be person's current location (Step S112). The transmitter 161 transmits the first location, which is the person's current location determined by the computing unit 153, to an external device by wireless communication, etc. (Step S113).

On the other hand, when the computing unit 153 has not detected any part of the output waveforms similar to any of the waveform models (NO at Step S109), the computing unit 153 determines the second location calculated by the computing unit 132 to be person's current location (Step S114). Furthermore, when the computing unit 153 has determined that the first location does not exist near the second location (NO at Step S111), the computing unit 153 determines the second location calculated by the computing unit 132 to be person's current location (Step S114). Accordingly, the transmitter 161 transmits the second location, which is the person's current location determined by the computing unit 153, to an external device by wireless communication, etc. (Step S113).

Result of Location Measurement According to First Embodiment

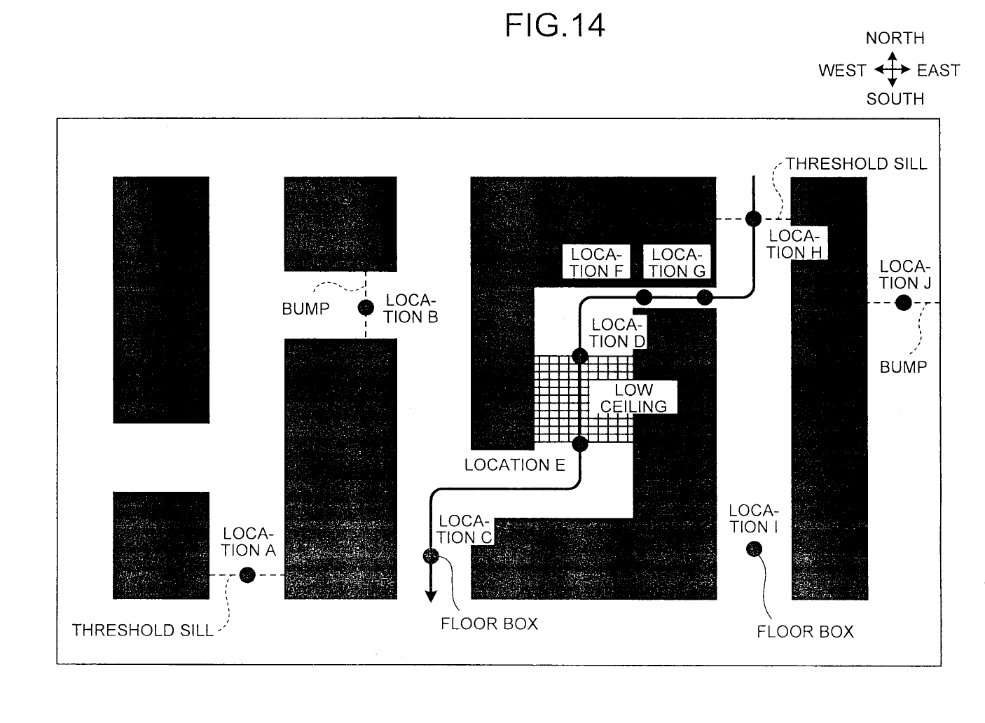

Subsequently, a result of the location measurement according to the first embodiment is explained with FIGS. 14 to 16. For example, assume that the person fitted with the information processing apparatus 100 has walked on a trajectory shown in FIG. 14. A directional line shown in FIG. 14 denotes the trajectory on which the person fitted with the information processing apparatus 100 has walked. For example, the person passes through “location H” after 3 seconds from the start of walking, and passes through “location G” after 7 seconds from the start of walking, and then passes through “location F” after 10 seconds from the start of walking. Also, the person passes through “location D” after 12 seconds from the start of walking, and passes through “location 5” after 16 seconds from the start of walking, and then passes through “location C” after 23 seconds from the start of walking.

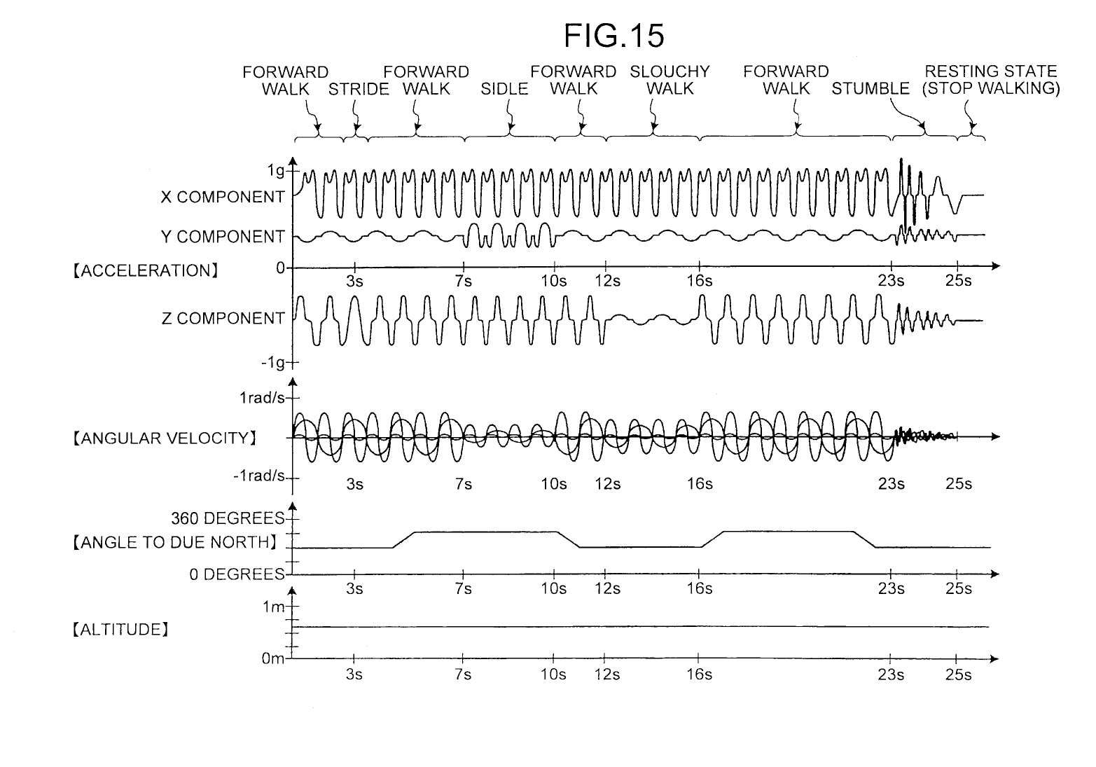

FIG. 15 represents an example of information measured by the sensors during person's walking on the trajectory shown in FIG. 14. Specifically, FIG. 15 represents numerical values of acceleration measured by the acceleration sensor 111, numerical values of angular velocity measured by the angular velocity sensor 112, the direction of the information processing apparatus 100 measured by the geomagnetic field sensor 113, and the altitude of the information processing apparatus 100 measured by the atmospheric pressure sensor 114. As compared with the waveform models shown in FIG. 12, we can find that the waveforms at the point of 3 seconds after the start of walking are similar to the waveform model for “stride”, and the waveforms in the period from 7 to 10 seconds after the start of walking are similar to the waveform model for “sidle”. Furthermore, we can find that the waveforms in the period from 12 to 16 seconds after the start of walking are similar to the waveform model for “slouchy walk”, and the waveforms at the point of 23 seconds after the start of walking are similar to the waveform model for “stumble”. From these, the computing unit 153 of the information processing apparatus 100 estimates the walking state to be “stride” at the point of 3 seconds after the start of walking and “sidle” in the period from 7 to 10 seconds after the start of walking with reference to the waveform models stored in the memory 152. Furthermore, the computing unit 153 of the information processing apparatus 100 estimates the walking state to be “slouchy walk” in the period from 12 to 16 seconds after the start of walking and “stumble” at the point of 23 seconds after the start of walking with reference to the waveform models stored in the memory 152.

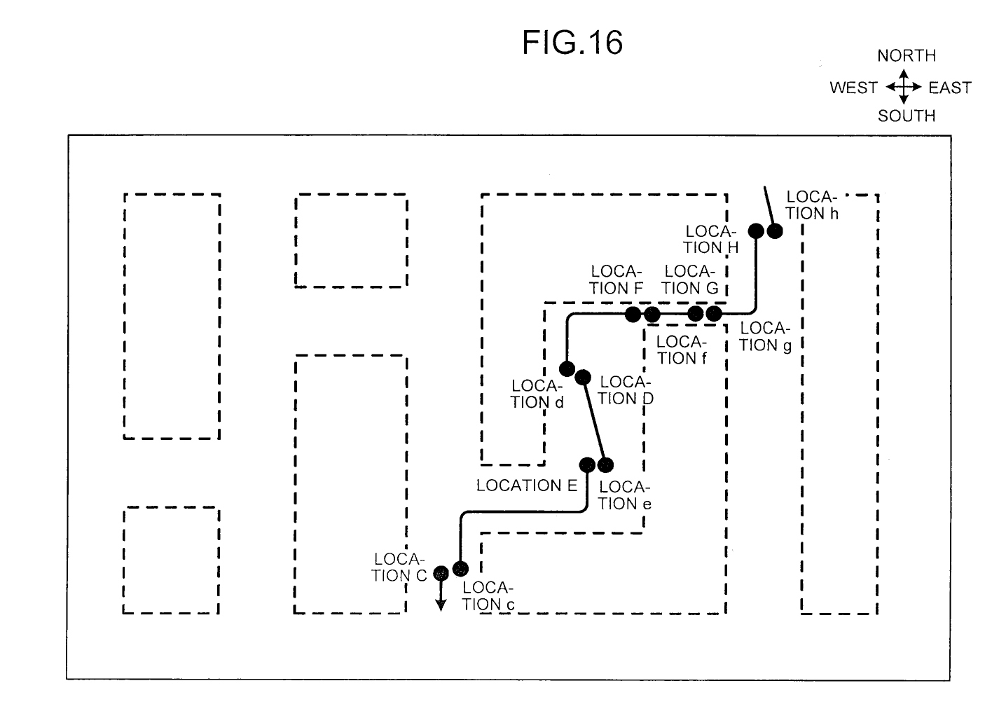

FIG. 16 represents an example of a trajectory of a location transmitted from the transmitter 161 when the person has walked on the trajectory shown in FIG. 14. In the example shown in FIG. 16, discontinuous parts are seen in the trajectory; these parts are signs of person's location replacement of a second location with a first location. For example, second locations at the points of 3 seconds, 7 seconds, 10 seconds, 12 seconds, 16 seconds, and 23 seconds after the start of walking are “location h”, “location g”, “location f”, “location d”, “location e”, and “location c”, respectively. At these second locations, walking states, such as “stride”, “sidle”, “slouchy walk”, and “stumble”, are estimated by the computing unit 153. Then, “location h”, “location g”, “location f”, “location d”, “location e”, and “location c” are replaced with “location H”, “location G”, “location F”, “location D”, “location E”, and “location C” on the basis of the correspondence information stored in the correspondence-information storage unit 140 (see FIG. 10).

### Effect of First Embodiment

The information processing apparatus 100 updates person's location estimated by the autonomous navigation according to a walking state associated with person's moving direction, and further updates the person's location according to a predetermined walking state of the person, and determines person's current location. Consequently, the information processing apparatus 100 can perform correction of a location measurement error due to the autonomous navigation with high quality. In other words, the information processing apparatus 100 further performs map matching for updating person's location estimated by the autonomous navigation according to a predetermined walking state in addition to map matching for updating the person's location according to a walking state associated with person's moving direction; therefore, the information processing apparatus 100 can perform correction of a location measurement error due to the autonomous navigation with high quality.

### Second Embodiment

The embodiment of the information processing apparatus 100 according to the present invention is explained above; however, besides the above-described embodiment, the present invention can be embodied in various different forms. Different embodiments of (1) the application of the information processing apparatus, (2) a configuration, and (3) a program are explained below.

(1) Application of Information Processing Apparatus

In the above embodiment, there is described the case where the information processing apparatus 100 is fitted on the abdomen of a person. However, the application of the information processing apparatus 100 is not limited to the above-described application example. Specifically, the location determining process can be performed by acquiring information required to determine person's location from outside. For example, the measuring unit 110 can be set up outside the information processing apparatus 100, and the information processing apparatus 100 can be realized as information equipment that receives measurement information from the external measuring unit 110 and performs the location determining process. Furthermore, the waveform models and correspondence information, etc. can be stored in an external storage device, and the information processing apparatus 100 can arbitrarily acquire information from the external storage device.

(2) Configuration

The processing procedures, control procedures, specific names, and information including various data and parameters illustrated in the above description and the drawings can be arbitrarily changed unless otherwise specified. Furthermore, components of the apparatus illustrated in the drawings are functionally conceptual ones, and do not always have to be physically configured as illustrated in the drawings. That is, the specific forms of division and integration of components of the apparatus are not limited to those illustrated in the drawings, and all or some of the components can be functionally or physically divided or integrated in arbitrary units depending on respective loads and use conditions, etc. For example, the correspondence information is not limited to that illustrated in the drawing, and varies according to the place where a person walks.

(3) Program

As one mode, a location determining program executed by the information processing apparatus 100 is recorded on a computer-readable recording medium, such as a CD-ROM, a flexible disk (FD), a CD-R, or a digital versatile disk (DVD), in an installable or executable file format, and the recording medium is provided. Furthermore, the location determining program executed by the information processing apparatus 100 can be stored on a computer connected to a network such as the Internet, and the location determining program can be provided by causing a user to download it via the network. Moreover, the location determining program executed by the information processing apparatus 100 can be provided or distributed via a network such as the Internet. Furthermore, the location determining program can be built into a ROM or the like in advance.

The location determining program executed by the information processing apparatus 100 is composed of modules including the above-described units (the correspondence-information storage unit 140 and the first-location deriving unit 150). A CPU (a processor) as actual hardware reads out the location determining program from a storage medium, and executes the location determining program, thereby the above units are loaded into the main memory, and the correspondence-information storage unit 140 and the first-location deriving unit 150 are generated on the main memory.

According to one aspect of the present invention, it is possible to perform correction of a location measurement error due to the autonomous navigation with high quality.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a storage unit that stores therein information of a walking state and a first location representing a location where the walking state occurs in an associated manner;
an estimating unit that estimates the walking state on the basis of measurement information measured in response to person's walking;
a judging unit that judges, when the walking state has been estimated, whether or not the first location associated with the estimated walking state exists near a second location representing a location calculated by autonomous navigation based on the measurement information; and
a determining unit that determines, when it has been judged that the first location exists near the second location, the first location to be person's current location.

2. The information processing apparatus according to claim 1, wherein
the storage unit stores therein walking states associated with obstacles to person's walking.

3. The information processing apparatus according to claim 1, wherein
the storage unit stores therein walking states associated with structure of a passage where a person walks.

4. The information processing apparatus according to claim 1, wherein
when the measurement information is similar to any of models of measurement information corresponding to predetermined walking states, the estimating unit estimates a walking state corresponding to the similar model to be person's walking state.

5. The information processing apparatus according to claim 4, wherein
the measurement information is at least one of acceleration and angular velocity,
when at least one of the acceleration and angular velocity measured in response to person's walking is similar to at least either one of models of acceleration and angular velocity corresponding to the predetermined walking states, the estimating unit estimates a walking state corresponding to the similar model to be person's walking state.

6. A location determining method comprising:
estimating person's walking state on the basis of measurement information measured in response to person's walking;
judging, when the walking state has been estimated, whether or not a first location corresponding to the estimated walking state exists near a second location representing a location calculated by autonomous navigation based on the measurement information on the basis of correspondence information that associates information of the walking state with the first location representing a location where the walking state occurs; and
determining, when it has been judged that the first location exists near the second location, the first location to be person's current location.

7. A non-transitory computer-readable recording medium that contains a location determining program causing a computer to execute:
estimating person's walking state on the basis of measurement information measured in response to person's walking;
judging, when the walking state has been estimated, whether or not a first location corresponding to the estimated walking state exists near a second location representing a location calculated by autonomous navigation based on the measurement information on the basis of correspondence information that associates information of the walking state with the first location representing a location where the walking state occurs; and
determining, when it has been judged that the first location exists near the second location, the first location to be person's current location.
